(19) United States
(12) Patent Application Publication
(10) Pub. No.: US 2012/0056857 A1
(43) Pub. Date: Mar. 8, 2012

(54) Display apparatus and display method thereof

(75) Inventors: Hsin-Yih Li, Taipei County (TW); Yueh-Hsiu Liu, Hsinchu City (TW)

(73) Assignee: NOVATEK MICROELECTRONICS CORP, Hsinchu (TW)

(21) Appl. No.: 13/064,436

(22) Filed: Mar. 24, 2011

(30) Foreign Application Priority Data
Sep. 2, 2010 (TW) 099129764

(51) Int. Cl. G06F 3/038

(52) U.S. Cl. 345/204

(57) ABSTRACT

A display apparatus and a display method thereof are provided. The display apparatus comprises a panel, an unusual status detecting unit, a status recognizing unit, a scan driver and a data driver. The unusual status detecting unit detects an unusual status to output a status feedback signal. The status recognizing unit transforms a first output enabling signal into a second output enabling signal according to the status feedback signal. The scan driver outputs a plurality of scan signals to drive the panel according to the clock signal and the second output enabling signal. The second output enabling signal masks at least one of the scan signals. The data driver outputs the data signals to the panel.

This application claims the benefit of Taiwan application Serial No. 99129764, filed Sep. 2, 2010, the subject matter of which is incorporated herein by reference.

### BACKGROUND OF THE INVENTION

1. Field of the Invention

The invention relates in general to a display apparatus and a display method thereof, and more particularly to a display apparatus and a display method thereof capable of avoiding erroneous frames being displayed.

2. Description of the Related Art

Referring to FIG. 1 and FIG. 2. FIG. 1 shows a conventional display apparatus. FIG. 2 shows a signal timing diagram of a conventional display apparatus. The conventional display apparatus 1 comprises a panel 11, a scan driver 14, a data driver 15 and a timing controller 16. The scan driver 14 further comprises a plurality of scan driving integrated circuits 142. The data driver 15 further comprises a plurality of data driving integrated circuits 152. The timing controller 16 outputs clock signals CLK and YCLK, a first output enabling signal YOE1, a data signal DATA1 and a data loading signal LD. The timing controller 16 further controls the scan driving integrated circuits 142 to output a plurality of scan signals G(1)˜G(N), and controls the data driving integrated circuits 152 to outputs a data signal DATA2.

However, the occurrence of unusual status, such as electrostatic discharge (ESD) and power noise, may easily cause data error to the data driver 15. In addition, the occurrence of unusual status may also cause the scan driver 34 to output erroneous scan signals. For example, when an unusual status 20 occurs to the data signal DATA2 of data driver 15 at data period T4, the data loading signal LD will control the data driver 15 to load the data signal DATA2 affected by the unusual status 20 to the data lines of the panel 31 at loading period T5. Since the corresponding scan signal G(2) is transformed into an enabling level, an erroneous frame will be displayed on the panel 11.

### SUMMARY OF THE INVENTION

The invention is directed to a display apparatus and a display method thereof. When an unusual status such as electrostatic discharge (ESD) and power noise occurs, corresponding scan signals are masked to avoid erroneous frames being displayed.

According to a first aspect of the present invention, a display apparatus is provided. The display apparatus comprises a panel, an unusual status detecting unit, a status recognizing unit, a scan driver and a data driver. The unusual status detecting unit detects an unusual status to output a status feedback signal. The status recognizing unit transforms a first output enabling signal into a second output enabling signal according to the status feedback signal. The scan driver outputs a plurality of scan signals to drive the panel according to the clock signal and the second output enabling signal. The second output enabling signal masks at least one of the scan signals. The data driver outputs the data signals to the panel.

According to a second aspect of the present invention, a display method is provided. The display method comprises the following steps. An unusual status is detected to output a status feedback signal. A first output enabling signal is transformed into a second output enabling signal according to the status feedback signal. A plurality of scan signals are outputted to a drive the panel according to the clock signal and the second output enabling signal. At least one of the scan signals is masked by the second output enabling signal. Data signals are outputted to the panel.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a conventional display apparatus;

FIG. 2 shows a signal timing diagram of a conventional display apparatus;

FIG. 3 shows a display apparatus according to an exemplary embodiment of the disclosure;

FIG. 4 shows a display method flowchart of according to an exemplary embodiment of the disclosure;

FIG. 5 shows a signal timing diagram according to an exemplary embodiment of the disclosure;

FIG. 6 shows a timing controller outputting a second enabling signal according to a status feedback signal outputted from a data driver;

FIG. 7 shows a timing controller outputting a second output enabling signal according to a status feedback signal outputted from a scan driver;

FIG. 8 shows a scan driver generating a second output enabling signal according to a status feedback signal outputted from a data driver;

FIG. 9 shows a first unusual status detecting unit;

FIG. 10 shows a signal timing diagram of a first unusual status detecting unit;

FIG. 11 shows a second unusual status detecting unit;

FIG. 12 shows a signal timing diagram of a second unusual status detecting unit; and

FIG. 13 shows a status recognizing unit.

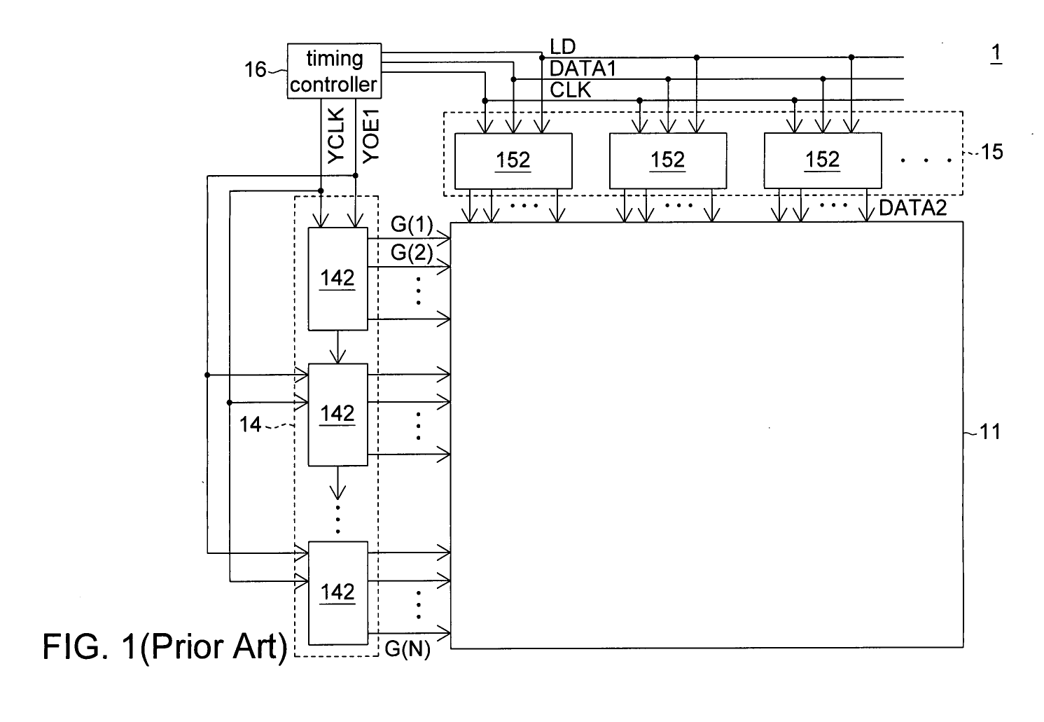

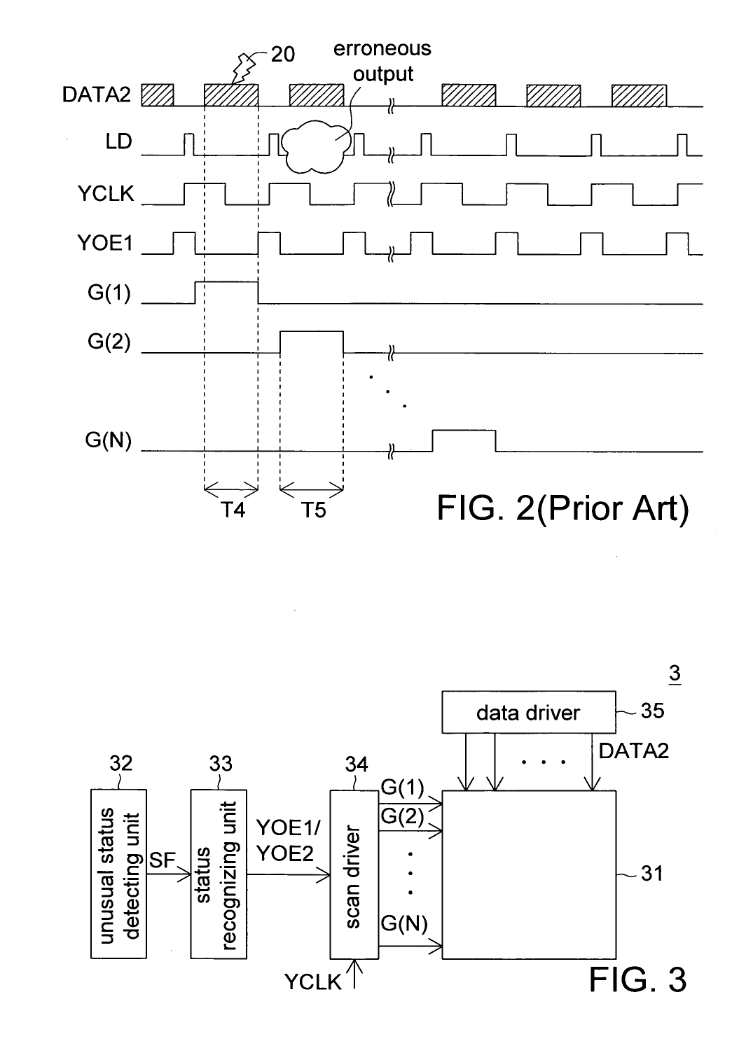

### DETAILED DESCRIPTION OF THE INVENTION

The following embodiments are related to a display apparatus and a display method thereof. The display apparatus comprises a panel, an unusual status detecting unit, a status recognizing unit, a scan driver and a data driver. The unusual status detecting unit detects an unusual status to output a status feedback signal. The status recognizing unit transforms a first output enabling signal into a second output enabling signal according to the status feedback signal. The scan driver outputs a plurality of scan signals to drive the panel according to the clock signal and the second output enabling signal. The second output enabling signal masks at least one of the scan signals. The data driver outputs the data signals to the panel,

The display method comprises the following steps. An unusual status is detected to output a status feedback signal. A first output enabling signal is transformed into a second output enabling signal according to the status feedback signal. A plurality of scan signals are outputted to a drive the panel according to the clock signal and the second output enabling signal. At least one of the scan signals is masked by the second output enabling signal. Data signals are outputted to the panel.

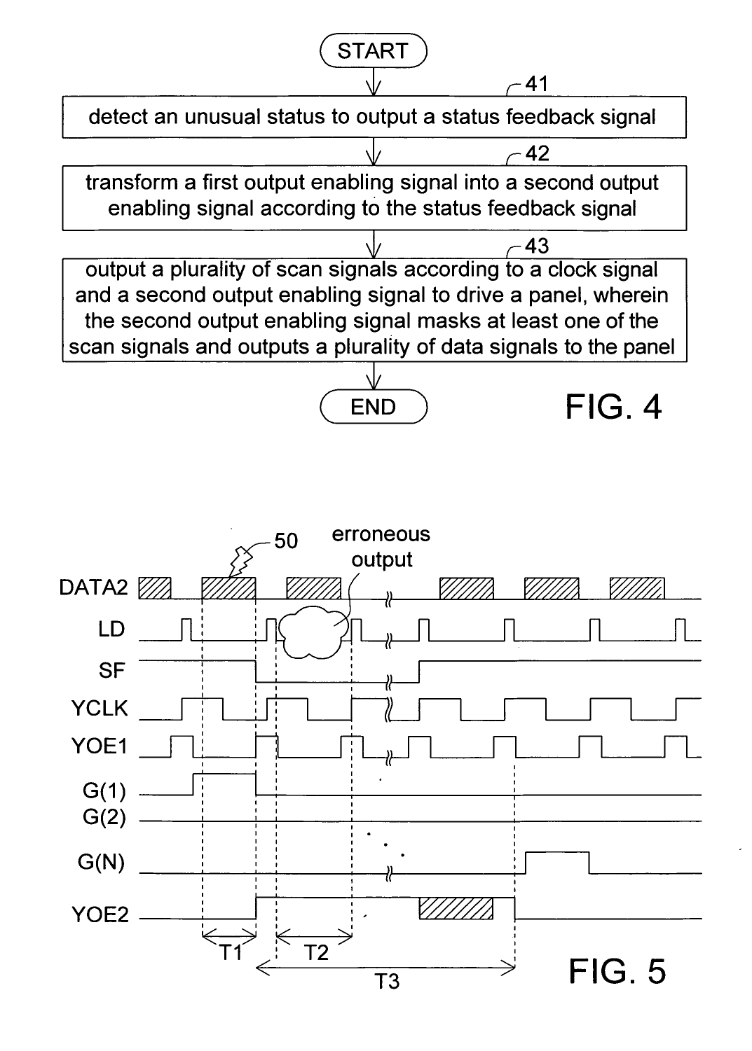

Referring to FIG. 3, FIG. 4 and FIG. 5. FIG. 3 shows a display apparatus according to an exemplary embodiment of the disclosure. FIG. 4 shows a display method flowchart of according to an exemplary embodiment of the disclosure. FIG. 5 shows a signal timing diagram according to an exemplary embodiment of the disclosure. The display apparatus 3 comprises a panel 31, an unusual status detecting unit 32, a status recognizing unit 33, a scan driver 34 and a data driver 35. Firstly, the method begins at step 41, an unusual status 50 is detected by the unusual status detecting unit 32 to output a status feedback signal SF, wherein the unusual status 50, such as electrostatic discharge (ESD) and power noise, may easily cause data error to the data driver 35. In addition, the unusual status 50 may also cause the scan driver 34 to output erroneous scan signals.

Next, the method proceeds to step 42, a first output enabling signal YOE1 is transformed into a second output enabling signal YOE2 by the status recognizing unit 33 according to the status feedback signal SF, wherein the pulse width of the second output enabling signal YOE2 is such as larger than that of the first output enabling signal YOE1. Then, the method proceeds to step 43, N scan signals G(1)˜G(N) are outputted by the scan driver 34 according to a clock signal YCLK and a second output enabling signal YOE2 to drive the panel 31. At least one of the scan signals G(1)˜G(N) is masked by the second output enabling signal YOE2. In addition, a plurality of data signals DATA2 are outputted to the panel 31 by the data driver 35. Since the second output enabling signal YOE2 will mask corresponding scan signals when the unusual status 50 occurs, no abnormal frame will be display by the display apparatus 3.

For example, when an unusual status 50 occurs to the data signals DATA2 of the data driver 35 at a data period T1, a data loading signal LD will control the data driver 35 to load the data signals DATA2 affected by the unusual status 50 to the data lines of the panel 31 at loading period T2, the second output enabling signal YOE2 will mask a corresponding scan signal G(2) at period T3, and the scan signal G(2) is at a non-enabling level, so that the panel 31 will not display erroneous data signals DATA2 that are affected by the unusual status 50. It is noted that the mask period T3 can be adjusted to a time allowing the second output enabling signal YOE2 to mask a plurality of scan signals or adjusted to an entire frame time.

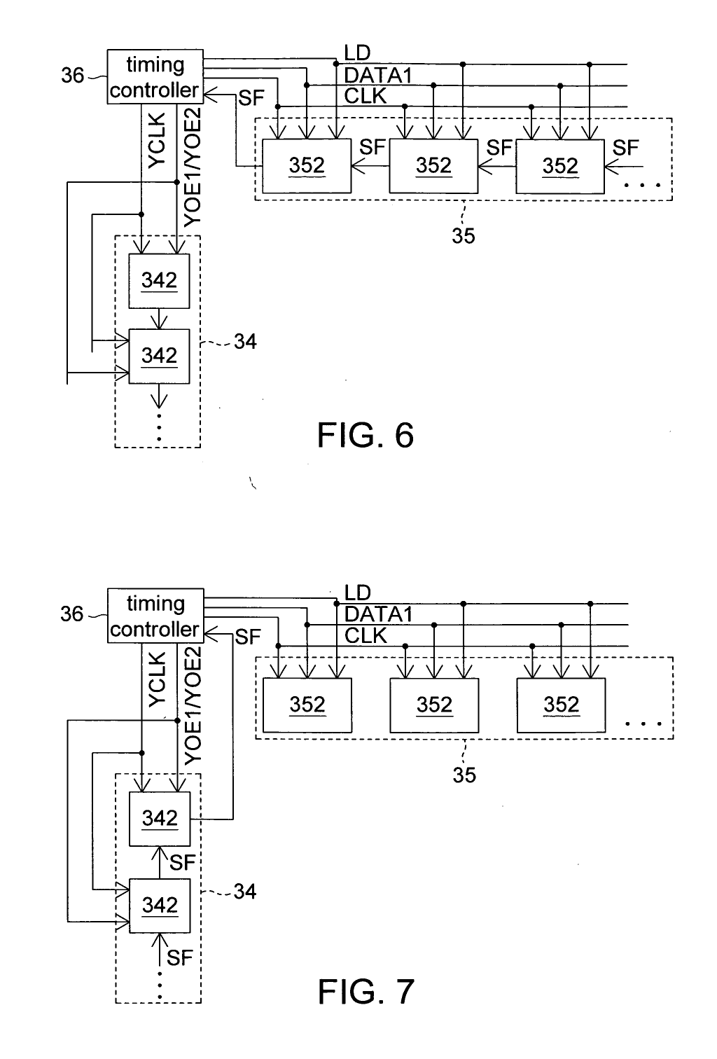

Referring to FIG. 6, a timing controller outputting a second enabling signal according to a status feedback signal outputted from a data driver is shown. The display apparatus 3 further comprises a timing controller 36. The scan driver 34 further comprises a plurality of scan driving integrated circuits 342. The data driver 35 further comprises a plurality of data driving integrated circuits 352. The foregoing unusual status detecting unit 32 is such as disposed in the data driving integrated circuits 352 for detecting an unusual status. The status recognizing unit 33 is such as disposed in the timing controller 36 for transforming the first output enabling signal YOE1 into a second output enabling signal YOE2 according to the status feedback signal SF.

Referring to FIG. 7, a timing controller outputting a second output enabling signal according to a status feedback signal outputted from a scan driver is shown. FIG. 7 is different from FIG. 6 in that: the foregoing unusual status detecting unit 32 is such as disposed in the scan driving integrated circuits 342 of the scan driver 34 for detecting an unusual status. The status recognizing unit 33 is disposed in the timing controller 36 for transforming the first output enabling signal YOE1 into a second output enabling signal YOE2 according to the status feedback signal SF.

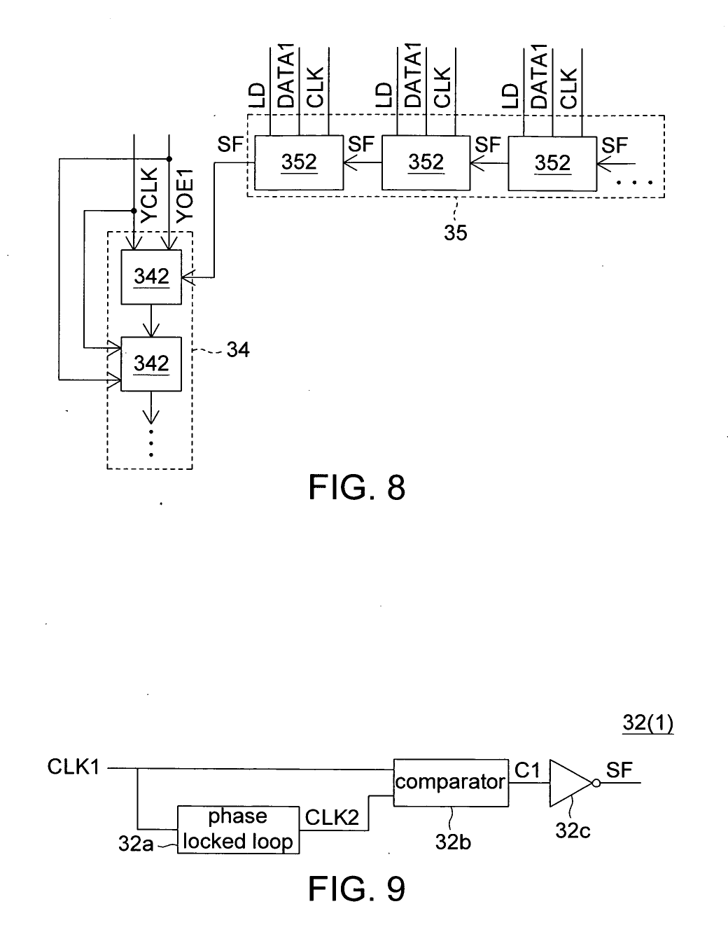

Referring to FIG. 8, a scan driver generating a second output enabling signal according to a status feedback signal outputted from a data driver is shown. FIG. 8 is different from FIG. 6 in that: the foregoing status recognizing unit 33 is such as disposed in the scan driving integrated circuits 342 of the scan driver 34 for transforming the first output enabling signal YOE1 into a second output enabling signal YOE2 according to the status feedback signal SF. The scan driving integrated circuits 342 outputs N scan signals G(1)˜G(N) according to the clock signal YCLK and the second output enabling signal YOE2.

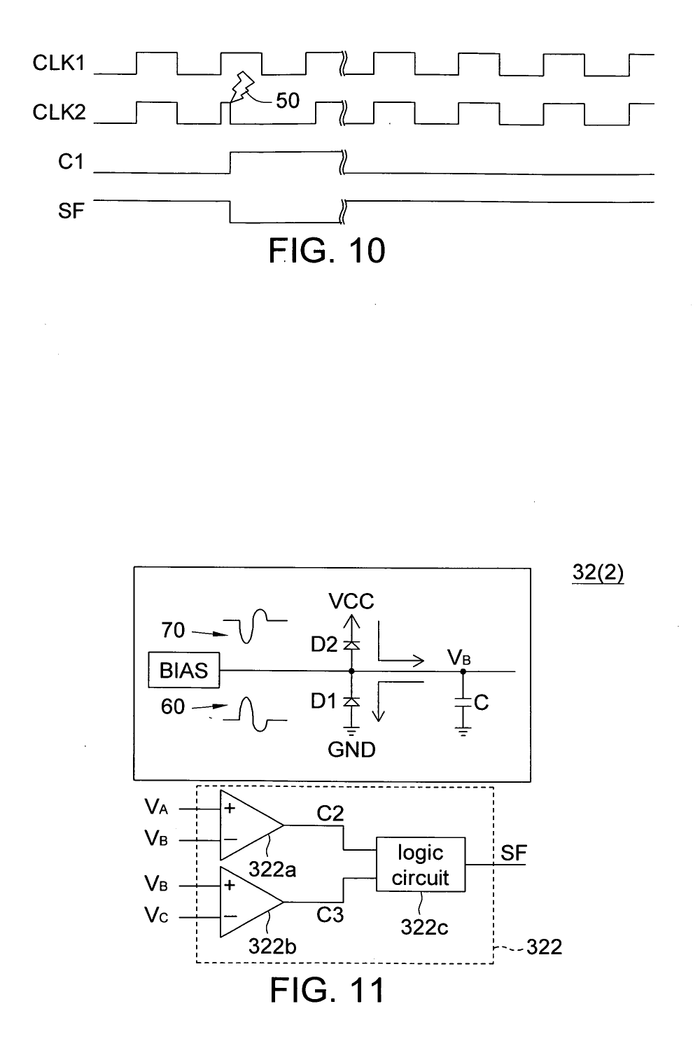

Referring to FIG. 9 and FIG. 10. FIG. 9 shows a first unusual status detecting unit. FIG. 10 shows a signal timing diagram of a first unusual status detecting unit. The foregoing unusual status detecting unit 32 is exemplified by an unusual status detecting unit 32(1) in FIG. 9. The unusual status detecting unit 32(1) comprises a phase locked loop 32a (PLL), a comparator 32b and a phase inverter 32c. The phase locked loop 32a receives a first clock signal CLK1 and outputs a second clock signal CLK2 according to the first clock signal CLK1.

The comparator 32b outputs a comparison signal C1 according to the first clock signal CLK1 and the second clock signal CLK2. Furthermore, after an unusual status 50 occurs, the frequency of the first clock signal CLK1 will differ with that of the second clock signal CLK2, so that the CLK2 outputs a comparison signal C1, and the phase inverter 32c further outputs a status feedback signal SF according to the comparison signal C1.

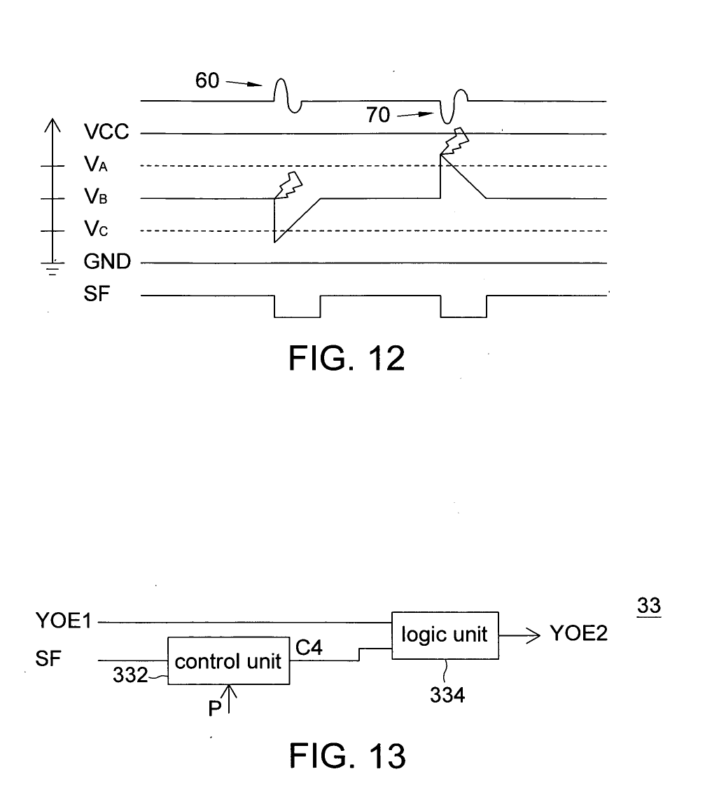

Referring to FIG. 11 and FIG. 12. FIG. 11 shows a second unusual status detecting unit. FIG. 12 shows a signal timing diagram of a second unusual status detecting unit. The foregoing unusual status detecting unit 32 is exemplified by the unusual status detecting unit 32(2) in FIG. 11. The unusual status detecting unit 32(2) comprises a capacitor C, a first diode D1, a second diode D2 and a bias voltage detection circuit 322. The first diode D1 and the capacitor C are coupled in parallel. The second diode D2 is coupled to the capacitor C and the first diode D1. The bias voltage detection circuit 322 outputs a status feedback signal SF when the storage voltage V_{B} of the capacitor C is larger than the first level V_{A} or smaller than the second level V_{C}.

Furthermore, the bias voltage detection circuit 322 comprises a first comparator 322a, a second comparator 322b and a logic circuit 322c. The logic circuit 322c is such as an AND gate. The first comparator 322a outputs a first comparison signal C2 according to the storage voltage V_{B} and the first level V_{A}. The second comparator 322b outputs a second comparison signal C3 according to the storage voltage V_{B} and the second level V_{C}. The logic circuit 322c outputs a status feedback signal SF according to the first comparison signal C2 and the second comparison signal C3.

For example, when the voltage of the power noise 60 is boosted so as to conduct the first diode D1, the capacitor C is discharged via the first diode D1, making the storage voltage V_{B} of the capacitor C decreased.

When the storage voltage V_{B} of the capacitor C is decreased to a second level V_{c}, the second comparator 322b outputs the second comparison signal C3. To the contrary, when the voltage of the power noise 70 is decreased so as to conduct the second diode D2, the capacitor C is charged via the second diode D2, making the storage voltage V_{B} of the capacitor C boosted. When the storage voltage V_{B} of the capacitor C is boosted to a first level V_{A}, the first comparator 322a outputs a first comparison signal C2, and the logic circuit 322c outputs a status feedback signal SF according to the first comparison signal C2 and the second comparison signal C3.

Referring to FIG. 13, a status recognizing unit is shown. The status recognizing unit 33 comprises a control unit 332 and a logic unit 334.

The control unit 332 outputs a control signal C4 according to the status feedback signal SF and a periodic signal P. The periodic signal P is such as the foregoing data loading signal LD or the clock signal YCLK. The control unit 332 such as counts a default value according to the periodic signal P. When the control unit 332 counts to the default value, a control signal C4 is immediately outputted to the logic unit 334, which further outputs the second output enabling signal YOE2 according to the control signal C4 and the first output enabling signal YOE1, wherein the logic unit 334 is such as an AND gate.

The display apparatus disclosed in above embodiments of the disclosure masks corresponding scan signals to avoid erroneous frames being displayed when unusual status occurs.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display apparatus, comprising:
a panel;
an unusual status detecting unit for detecting an unusual status to output a status feedback signal;
a status recognizing unit for transforming a first output enabling signal into a second output enabling signal according to the status feedback signal;
a scan driver for outputting a plurality of scan signals according to a clock signal and a second output enabling signal to drive the panel, wherein the second output enabling signal masks at least one of the scan signals; and
a data driver for outputting a plurality of data signals to the panel.

2. The display apparatus according to claim 1, wherein the unusual status detecting unit comprises:
a phase locked loop (PLL) for receiving a first clock signal and outputting a second clock signal according to the first clock signal;
a comparator for outputting a comparison signal according to the first clock signal and the second clock signal; and
a phase inverter for outputting the status feedback signal according to the comparison signal.

3. The display apparatus according to claim 1, wherein the unusual status detecting unit comprises:
a capacitor;
a first diode coupled to the capacitor in parallel;
a second diode coupled to the capacitor and the first diode; and
a bias voltage detection circuit for outputting the status feedback signal when a storage voltage of the capacitor is larger than a first level or smaller than a second level.

4. The display apparatus according to claim 3, wherein the bias voltage detection circuit comprises:
a first comparator for outputting a first comparison signal according to the storage voltage and the first level;
a second comparator for outputting a second comparison signal according to the storage voltage and the second level; and
a logic circuit for outputting the status feedback signal according to the first comparison signal and the second comparison signal.

5. The display apparatus according to claim 1, wherein the status recognizing unit comprises:
a control unit for outputting a control signal according to the status feedback signal and a periodic signal; and
a logic unit for outputting the second output enabling signal according to the control signal and the first output enabling signal.

6. A display method, comprising:
detecting an unusual status to output a status feedback signal;
transforming a first output enabling signal into a second output enabling signal according to the status feedback signal; and
outputting a plurality of scan signals according to a clock signal and a second output enabling signal to drive a panel, wherein the second output enabling signal masks at least one of the scan signals and outputs a plurality of data signals to the panel.

7. The display method according to claim 6, wherein the step of detecting an unusual status to output a status feedback signal comprises:
inputting a first clock signal to a phase locked loop (PLL) to output a second clock signal;
outputting a comparison signal according to the first clock signal and the second clock signal; and
outputting the status feedback signal according to the comparison signal.

8. The display method according to claim 6, wherein the step of detecting an unusual status to output a status feedback signal comprises:
detecting a storage voltage of a capacitor and outputting the status feedback signal when the storage voltage is larger than a first level or smaller than a second level.

9. The display method according to claim 8, wherein the step of outputting the status feedback signal comprises:
outputting a first comparison signal according to the storage voltage and the first level;
outputting a second comparison signal according to the storage voltage and the second level; and
outputting the status feedback signal according to the first comparison signal and the second comparison signal.

10. The display method according to claim 6, wherein the step of transforming a first output enabling signal into a second output enabling signal according to the status feedback signal comprises:
outputting a control signal according to the status feedback signal and a periodic signal; and
outputting the second output enabling signal according to the control signal and the first output enabling signal.
